(19) United States
(12) Patent Application Publication
(10) Pub. No.: US 2010/0247411 A1
(43) Pub. Date: Sep. 30, 2010

(54) HIGHLY ACIDIC COMPOSITIONS COMPRISING ZIRCONIUM OXIDE, TITANIUM OXIDE AND TUNGSTEN OXIDE AND TREATMENT OF EXHAUST GASES THEREWITH

(75) Inventors: Olivier Larcher, Perigny (FR); Emmanuel Rohart, Sainte Soulle (FR); Stephan Verdier, Lyon (FR); Heather Bradshaw, Manchester Greater Manchester (GB); Clive Butler, Manchester Greater Manchester (GB); Deborah Harris, Manchester Greater Manchester (GB); Mairead Feeley, Manchester (GB); Hazel Stephenson, Manchester Greater Manchester (GB)

Correspondence Address: BUCHANAN, INGERSOLL & ROONEY PC, POST OFFICE BOX 1404, ALEXANDRIA, VA, 22313-1404, US

(73) Assignees: RHODIA OPERATIONS, Aubervilliers (FR); MAGNESIUM ELEKTRON LIMITED, Greater Manchester (GB)

(21) Appl. No.: 12/446,184

(22) PCT Filed: Oct. 19, 2007
(86) PCT No.: PCT/EP2007/061236

§ 371 Date: May 18, 2010

(30) Foreign Application Priority Data
Oct. 20, 2006 (FR) 06 09223

(51) Int. Cl. B01J 23/30; B01D 53/62; B01D 53/56

(52) U.S. Cl. 423/239.1; 502/309; 423/245.3

(57) ABSTRACT

Compositions useful for treating exhaust gases contain zirconium, titanium and tungsten oxides, and optionally the oxide of an element M selected from among silicon, aluminum, iron, molybdenum, manganese, zinc, tin, and rare earths in the following mass proportions of these different elements: titanium oxide: 20%-50%; tungsten oxide: 1%-20%, M-element oxide: 1%-20%; the balance being zirconium oxide; such compositions are prepared by placing in a liquid medium a zirconium compound, a titanium compound, optionally an M-element compound and a basic compound, adding a tungsten compound to the precipitate suspension thus obtained and having a pH value ranging from 1 to 7, maturing the suspension resulting from the preceding step, and optionally separating the precipitate and calcining same.

The present invention relates to a composition of high acidity based on zirconium oxide, titanium oxide and tungsten oxide, to its preparation process and to its use especially in the treatment of exhaust gases.

It is known to use, for the treatment of exhaust gases from diesel engines, oxidation catalysts that have the effect of catalyzing the oxidation of carbon monoxide (CO) and the hydrocarbons (HC) contained in these gases. However, the latest diesel engines produce gases that have higher CO and HC concentrations than the older engines. In addition, as a result of the tightening of pollution control standards, the exhaust lines of diesel engines will in the future have to be fitted with particulate filters. However, the catalysts are also used to raise the temperature of the exhaust gases to a high enough level to trigger the regeneration of these filters. It is understood therefore that there is a need for catalysts which have improved effectiveness, since they must treat gases with higher pollutant concentrations and which also have improved temperature resistance, since these catalysts risk being subjected to higher temperatures during the regeneration of the filters.

It is also known that, in the case of treating diesel engine gases by reduction of the nitrogen oxides (NOx) by urea or aqueous ammonia, there is a need to have catalysts having a certain acidity and, here too, a certain temperature resistance.

Finally it is known that there is also a need for catalysts which have performance characteristics that are not very sensitive to sulfation.

The object of the invention is to provide materials capable of being used in the manufacture of catalysts satisfying these needs.

With this aim, the composition according to the invention is based on zirconium oxide, titanium oxide and tungsten oxide in the following proportions by mass of these various components:
titanium oxide: 20%-50%
tungsten oxide: 1%-20%

the remainder being zirconium oxide, and it is characterized in that it has moreover an acidity measured by the methylbutynol test of at least 90%.

According to another embodiment of the invention, the composition is based on zirconium oxide, titanium oxide, tungsten oxide and at least one oxide of another element M chosen from silicon, aluminum, iron, molybdenum, manganese, zinc, tin and the rare earths in the following proportions by mass of these various components:
titanium oxide: 20%-50%
tungsten oxide: 1%-20%
oxide of the element M: 1%-20%

the remainder being zirconium oxide, and it is characterized in that it has moreover an acidity measured by the methylbutynol test of at least 90%.

Through its acidity, the composition of the invention confers good catalytic activity on the catalysts in the manufacture of which it is used.

Furthermore, and as another advantage, the composition of the invention has an improved resistance to sulfation.

Other features, details and advantages of the invention will appear even more completely on reading the description that follows and also various concrete but non-limiting examples intended by way of its illustration.

For the rest of the description, the term “specific surface area” is understood to mean the BET specific surface area determined by nitrogen adsorption in accordance with the ASTM D3663-78 standard established from the Brunauer-Emmett-Teller method described in “The Journal of the American Chemical Society, 60, 309 (1938)”.

The term “rare earths” is understood to mean the elements of the group made up of yttrium and the elements of the Periodic Table of atomic number between 57 and 71 inclusive.

The Periodic Table of the Elements to which reference is made is that published in the “Supplement au Bulletin de la Société Chimique de France” [Supplement to the Bulletin of the French Chemical Society], No. 1 (January 1966).

Furthermore, the calcinations, at the end of which the surface area values are given, are calcinations in air.

The specific surface area values that are indicated for a given temperature and duration correspond, except where indicated otherwise, to calcinations in air at a temperature hold over the duration indicated.

The contents are given by mass and as the oxide, except where indicated otherwise.

It is also stated for the rest of the description that, except where indicated otherwise, in the ranges of values which are given, the values are inclusive of the limits.

The compositions according to the invention are characterized firstly by the nature of their constituents.

As indicated above, these compositions are based on zirconium oxide (ZrO₂), titanium oxide (TiO₂) and tungsten oxide (WO₃) and in the proportions indicated.

The proportion of zirconium oxide may more particularly be at least 40% and it may especially be between 40% and 60%.

According to one variant the proportion of zirconium oxide may be between 50% and 55%, that of titanium oxide between 30% and 35% and that of tungsten oxide between 5% and 10%, this variant applying to two embodiments of the invention.

Regarding the element M, its content may more particularly be between 1% and 10%.

The highest contents of element M, that is to say in a range of 10% to 20%, preferably applies to the case where this element is silicon.

In the case of the rare earths, the element M may be more particularly cerium and yttrium.

Finally it is noted that the compositions of the invention may comprise a combination of one or more elements M, it being understood that in the case of the presence of several elements M the total content of these elements remains within the aforesaid range of 1% to 20%. As examples of compositions having several elements M, mention may be made of the compositions comprising, besides the oxides of zirconium, titanium and tungsten, silicon oxide and an oxide of a rare earth element, this rare earth element possibly being, more particularly, cerium or else silicon oxide and iron oxide, or silicon oxide and, manganese oxide or finally cerium oxide and manganese oxide.

An important characteristic of the compositions of the invention is their acidity. This acidity is measured by the methylbutynol test that will be described further on, and it is at least 90% and, more particularly, it may be at least 95%.

This acidity may also be evaluated by the acid activity that is also measured by the methylbutynol test and that characterizes a product's acidity independently of its surface.

This acid activity is at least 0.05 mmol/h/m², more particularly at least 0.075 mmol/h/m². It may, more particularly still, be at least 0.09 mmol/h/m² and especially at least 0.13 mmol/h/m².

The compositions of the invention have a large specific surface area. This surface area may be in fact at least 50 m²/g after calcination at 750° C. for 2 hours. In the case of the composition of which the element M is silicon and/or aluminum, this surface area, measured under the same conditions, may more particularly be at least 100 m²/g. In the case of the latter compositions, this surface area may be at least 40 m²/g after calcination at 950° C. for 2 hours.

The compositions of the invention may be in the form of a mixture of oxides of the various elements making up their formulation. The various phases present in the composition may be detected by the technique of X-ray diffraction.

However, according to an advantageous variant, the tungsten and, where appropriate, M elements may not be presented in the form of their corresponding oxide, which shows that they are in solid solution with the other elements of the composition.

According to an even more advantageous variant, these compositions may be in the form of a solid solution even after calcination at 750° C. for 2 hours. By this it is understood that the tungsten and, where appropriate, M elements are in solid solution in a phase which, in the case of the latter variant, is a single crystalline phase that may be ZrTiO₄, a tetragonal zirconia or else titanium oxide in anatase form, depending on the relative quantities of zirconium and titanium in the composition. This characteristic may be demonstrated by X-ray diffraction analysis of the composition. The XRD diagrams in this case do not reveal peaks corresponding to an oxide of the tungsten or M elements, they only show the presence of a single crystalline phase, for example of the type of those mentioned above.

The compositions of the invention may also have a sulfate content which may be very low. This content may be at most 800 ppm, more particularly at most 500 ppm, more particularly still at most 100 ppm, this content being expressed as mass of SO₄ relative to the whole of the composition. This content is measured by a LECO or ELTRA type device, that is to say by a technique using a catalytic oxidation of the product in an induction furnace and an IR analysis of the SO₂ formed.

Furthermore, the compositions of the invention may also have a chlorine content which may be very low. This content may be at most 500 ppm, especially at most 200 ppm, more precisely at most 100 ppm, more particularly at most 50 ppm and more particularly still at most 10 ppm. This content being expressed by mass of Cl relative to the whole of the composition.

Finally, the compositions of the invention may also have a content of an alkali-metal element, especially of sodium, of at most 500 ppm, especially at most 200 ppm, more particularly at most 100 ppm, more particularly still at most 50 ppm. This content being expressed as mass of the element, for example mass of Na, relative to the whole of the composition.

These chlorine and alkali metal contents are measured by the ion chromatography technique.

The process for preparing the compositions of the invention will now be described.

This process, according to a first embodiment, is characterized in that it comprises the following steps:

(a) bringing together in a liquid medium a zirconium compound, a titanium compound, possibly a compound of the element M and a basic compound through which a precipitate is obtained;

(b) forming a suspension comprising the precipitate from step (a) or starting from the suspension from step (a), and either adding a tungsten compound thereto and adjusting the pH of the medium to a value between 1 and 7, or adjusting the pH of the suspension formed in this way to a value between 1 and 7 and adding a tungsten compound thereto;

(c) carrying out a maturing operation on the suspension from the previous step; and

(d) calcining, possibly after drying, the product from the previous step.

The first step of the process consists therefore in bringing together, in a liquid medium, the zirconium and titanium compounds and, in the case of the second embodiment, a compound of the element M. These various compounds are present in the stoichiometric quantities necessary to obtain the desired final composition.

The liquid medium is generally water.

The compounds are preferably soluble compounds. The zirconium and titanium compounds may especially be oxysulfates or oxynitrates, but preferably oxy-chlorides are used for these two elements.

For the compound of the element M, in the case of silicon, an alkali metal silicate may be used and mention may be made, more particularly, of sodium silicate. The silicon may also be supplied by a silica sol such as, for example, MORRISOL or LUDOX sold by Morrisons Gas Related Products Limited and Grace Davison respectively, or else by an organometallic compound such as sodium tetraethyl orthosilicate (TEOS), potassium methyl siliconate or an analogous methyl siliconate.

In the case of aluminum, aluminum nitrate Al(NO₃)₃, aluminum chlorohydrate Al₂(OH)₅Cl or boehmite AlO(OH) may be used.

In the case of the rare earths, iron, tin, zinc and manganese, the inorganic or organic salts of these elements may be used. Mention may be made of chlorides or acetates and, more particularly, nitrates. Even more particular mention may be made of tin (II) or (IV) chloride or zinc nitrate.

Finally, for molybdenum, ammonium heptamolybdate (NH₄)₆Mo₇O₂₄.4H₂O may be used.

As the basic compound, hydroxide or carbonate type products may be used. Mention may be made of alkali metal hydroxides or alkaline-earth metal hydroxides and ammonia. Secondary, tertiary or quaternary amines may also be used. Urea may also be mentioned. Sodium hydroxide may be used most particularly.

The bringing together of various compounds may be achieved in various ways. Preferably the various compounds may be introduced in the following order: water, zirconium compound, titanium compound then silicon compound and possibly the compound of the element M, then the medium thus formed is brought into contact with the basic compound.

It is possible at this stage of the process, that is to say at the time of this precipitation step, to use additives of the type to facilitate the implementation of this process and also the production of compositions in the form of solid solutions, such as sulfates, phosphates or polycarboxylates.

It is also possible to conduct this first step in the presence of hydrogen peroxide or else to add hydrogen peroxide right at the end of this first step, this also being to facilitate the implementation of the process.

Step (a) of the process may be conducted at a temperature between 15° C. and 80° C. especially.

Preferably, before implementing the second step (b), the precipitate obtained in step (a) is separated, this separation being able to be carried out by any conventional solid-liquid separation technique such as, for example, filtration, settling, drying or centrifuging. The precipitate thus separated may then possibly be washed, for example with water, and put back into suspension in water. It is on this suspension obtained in this way that step (b) is then implemented. It may be advantageous, before carrying out the next step and possibly the separation of the precipitate obtained in step (a), to heat the medium to a temperature which may be between 40° C. and 100° C.

The second step of the process consists in forming a suspension comprising the precipitate from step (a) or in starting from the suspension from step (a) and in adding a tungsten compound thereto. After the addition of this compound the pH of the medium is adjusted to a value between 1 and 7. This value may be more particularly between 3 and 5. It is also possible to proceed by first of all adjusting, in the same range, the pH value of the suspension formed from the precipitate from step (a) and by next adding the tungsten compound. The pH adjustment may be carried out, for example, by addition of nitric acid.

As the tungsten compound, mention may be made of ammonium metatungstate (NH₄)₆W₁₂O₄₁ and sodium metatungstate Na₂WO₄.

Also preferably, before the next step (c) is implemented, the precipitate obtained from step (b) may be separated. This separation may be carried out by any known solid-liquid separation technique, for example, by filtration, settling, drying or centrifuging. It is also possible to wash the precipitate after the separation, for example with water, then put it back into suspension in water. Step (c) is then implemented on the suspension obtained in this way. It may be advantageous, before carrying out the next step and possibly the separation of the precipitate obtained in step (b), to heat the medium to a temperature which may be between 40° C. and 100° C.

The third step in the process consists in carrying out a maturing operation on the suspension from the previous step (b).

This maturing operation is carried out by heating the medium. The temperature to which the medium is heated is at least 60° C., more particularly at least 90° C. and even more particularly at least 140° C. The medium is thus maintained at a constant temperature over a duration that is normally 6 hours at most. The maturing operation may be carried out at atmospheric pressure or possibly at elevated pressure. Before the maturing operation is carried out, the pH of the medium may be adjusted to a value between 3 and 10, preferably between and 5. The pH adjustment may be carried out, for example, by addition of nitric acid.

At the end of the maturing step, a suspension is obtained containing a mass of a solid precipitate that may possibly be dried and is then calcined in the last step (d) of the process.

The precipitate may be separated from its liquid medium by the aforementioned known techniques before possible drying and before calcination. The product obtained in this way may be subjected to one or more washes with water or with acidic or basic aqueous solutions.

According to another variant, the suspension obtained from step (c) may also be calcined, possibly after a drying step, without liquid/solid separation.

In the case of drying, the drying temperature is generally between 50° C. and 300° C., preferably between 100° C. and 150° C.

Alternatively, the suspension may be subjected to spray-drying. The term “spray-drying” is understood to mean, in the present description, drying by spraying the suspension in a hot atmosphere. The spray-drying may be carried out by any sprayer known per se, for example by a spray nozzle of the sprinkler-rose type or another type. It is also possible to use atomizers called turbine atomizers. With regard to the various spraying techniques that can be used in the present process, reference may be made especially to the fundamental work of Masters entitled “Spray-drying” (second edition, 1976, published by George Godwin, London).

In this case the inlet temperature of the gases may be between 200° C. and 600° C., preferably between 300° C. and 400° C.

The drying operation may also be carried out by lyophilization.

The powder obtained may then be calcined under the conditions given below:

The calcination of step (d) makes it possible to develop the crystallinity of the product formed and it may also be adjusted as a function of the subsequent operating temperature reserved for the composition, and this being done while taking into account the fact that the specific surface area of the product is smaller the higher the calcination temperature used and/or the longer the duration of calcination. Such a calcination is generally carried out in air.

In practice, the calcination temperature is generally limited to a range of values between 500° C. and 900° C., more particularly between 700° C. and 900° C.

The duration of this calcination may vary within a wide range, and is, in principle, greater the lower the temperature. Purely by way of example, this duration may vary between 2 hours and 10 hours.

Another embodiment of the process of the invention will also be described.

According to this embodiment, which applies to the preparation of compositions comprising one element M, the process comprises the following steps:

(a′) bringing together in a liquid medium a zirconium compound, a titanium compound and a basic compound through which a precipitate is obtained;

(b′) forming a suspension comprising the precipitate from step (a′) or starting from the suspension from step (a′), adding a tungsten compound and a compound of the element M thereto, and adjusting the pH of the medium to a value between 1 and 7;

(c′) possibly carrying out a maturing operation on the suspension from the previous step; and

(d′) calcining, possibly after drying, the product from the previous step.

This process differs from that according to the first embodiment by the step of introducing the element M, this introduction taking place in a second step and not in the first. The maturing step is, in addition, optional. Considering the similarities between the two embodiments, everything which has been described above for the first embodiment applies likewise to the second embodiment for the common parts.

A third embodiment of the process may also be carried out for the preparation of compositions comprising at least two elements M. The process according to this third embodiment comprises the following steps:

(a″) bringing together in a liquid medium a zirconium compound, a titanium compound and a basic compound through which a precipitate is obtained;

(b″) forming a suspension comprising the precipitate from step (a″) or starting from the suspension from step (a″), and adding a tungsten compound and a compound of at least one of the elements M thereto, and adjusting the pH of the medium to a value between 1 and 7;

(c″) possibly carrying out a maturing operation on the suspension from the previous step;

(d″) separating the precipitate from the medium from step (c″), putting it back into suspension in water and adding, to the suspension obtained, a compound of at least one other element M; and

(e″) calcining, possibly after drying, the product from the previous step.

This third embodiment differs from the second by an additional step (d″) in which the second element M is introduced. Here too, considering the similarities between the embodiments, what has been described above for the common parts of these various embodiments also applies here. It will be noted that the drying from step (e″) can more particularly be carried out by spray-drying.

Finally, it is possible to use a process according to a fourth embodiment again for preparing compositions comprising at least two elements M. In this case, the process comprises the following steps:

(a₁) bringing together in a liquid medium a zirconium compound, a titanium compound, a compound of at least one of the elements M and a basic compound through which a precipitate is obtained;

(b₁) forming a suspension comprising the precipitate from step (a₁) or starting from the suspension from step (a₁), and adding a tungsten compound and a compound of at least one other of the elements M thereto, and adjusting the pH of the medium to a value between 1 and 7;

(c₁) possibly carrying out a maturing operation on the suspension from the previous step; and

(d₁) calcining, possibly after drying, the product from the previous step.

This embodiment differs from the third by the order of introducing the elements M. What has been described above for the steps common or similar to the various embodiments also applies here.

The compositions of the invention as described above or such as those obtained by the aforementioned process are in powder form but they may possibly be shaped so as to be in the form of tablets, granules, balls, cylinders or monoliths or filters in the form of honeycombs of various sizes. These compositions may be applied to any support commonly used in the catalysis field, that is to say, especially thermally inert supports. This support may be chosen from alumina, titanium oxide, cerium oxide, zirconium oxide, silica, spinels, zeolites, silicates, crystalline silicon-aluminum phosphates and crystalline aluminum phosphates.

The compositions may also be used in catalyst systems. The invention therefore also relates to catalyst systems containing compositions of the invention. These catalyst systems may comprise a coating (wash coat) having catalytic properties and being based on these compositions, on a substrate of for example the metallic or ceramic monolith type. The coating may also itself comprise a support of the type of those mentioned above. This coating is obtained by mixing the composition with the support so as to form a suspension that may then be deposited on the substrate.

In the case of these uses in catalyst systems, the compositions of the invention may be employed in combination with transition metals; thus they act as support for these metals. The term “transition metals” is understood to mean the elements of Groups IIIA to IIB of the Periodic Table. As transition metals, mention may be made more particularly of vanadium and copper and also precious metals, such as platinum, silver or iridium. The nature of these metals and the techniques for incorporating them into the support compositions are well known to those skilled in the art. For example, the metals may be incorporated into the compositions by impregnation.

The catalyst systems of the invention may be used for treating gases. They may act in this case as catalyst for the oxidation of the CO and hydrocarbons contained in these gases, or else as catalyst for the reduction of the nitrogen oxides (NOx) in the reduction reaction of these NOx by aqueous ammonia or urea and, in this case, as catalyst for the reaction of hydrolysis or decomposition of the urea to form aqueous ammonia (SCR process).

The gases that can be treated within the scope of the present invention are, for example, those emitted by stationary installations such as gas turbines and thermal power station boilers. They may also be gases from internal combustion engines and most particularly exhaust gases from diesel engines.

In the case of the use in the catalysis of the reduction reaction of NOx by urea or aqueous ammonia, the compositions of the invention may be employed in combination with metals of the transition metal type such as vanadium or copper.

Examples will now be given.

First of all, the methylbutynol test used to characterize the acidity of the compositions according to the invention is described below.

This catalyst test is described by Pernot et al. in Applied Catalysis, 1991, Vol. 78, p 213 and uses 2-methyl-3-butyn-2-ol (methylbutynol or MBOH) as a probe molecule for the surface acidity/basicity of the prepared compositions. Depending on the acidity/basicity of the sites on the surface of the composition, methylbutynol may be converted according to 3 reactions:

TABLE 1

| Reaction | Reaction products |
|---|---|
| Acid | 2-methyl-1-buten-3-yne + |
| | 3-methyl-2-butenal |
| Amphoteric | 3-hydroxy-3-methyl-2-butanone + |
| | 3-methyl-3-buten-2-one |
| Basic | acetone + acetylene |

Experimentally, a quantity (m) of about 400 mg of the composition is placed in a quartz reactor. The composition first underwent a pretreatment at 400° C. for 2 h under a N₂ gas flow at a rate of 4 l/h.

The temperature of the composition is then lowered to 180° C. The composition is then brought into contact, in a periodic manner, with given quantities of MBOH. This periodic contacting consists in making, over the course of a 4 minute injection, a synthetic mixture of 4 vol % of MBOH in N₂ circulate with a flow rate of 4 l/h, which corresponds to an hourly molar rate of methylbutynol (Q) of 7.1 mmol/h. Ten injections are carried out. At the end of each injection the gas flow exiting the reactor is analyzed by gas chromatography in order to determine the nature of the reaction products (cf. Table 1) and their quantity.

The selectivity (Sᵢ) of a product i of the methylbutynol conversion reaction is defined by the proportion of this product relative to the total products formed (Sᵢ=Cᵢ/Σ where Cᵢ is the quantity of product i and Σ represents the sum of the products formed during the reaction). An acid, amphoteric or basic selectivity equal to the sum of the selectivities of the products formed for the acidic, amphoteric or basic reactions respectively is then defined. For example, the acid selectivity (S_{[acid]}) is equal to the sum of the 2-methyl-1-buten-3-yne and 3-methyl-2-butenal selectivities. Thus the higher the acid selectivity, the larger the quantities of acid reaction products formed and the higher the number of acid sites on the composition studied.

The degree of conversion (DC) of methylbutynol over the course of the test is calculated by taking the average of the degrees of conversion of methylbutynol over the last 5 injections of the test.

It is also possible to define the acid activity (A_{[acid]}) of the composition, expressed in mmol/h/m², from the degree of conversion (DC, expressed in %) of methylbutynol, from the hourly molar rate of methylbutynol (Q, expressed in mmol/h), from the acid selectivity (S_{[acid]}, expressed in %), from the quantity of composition analyzed (m, expressed in g) and from the specific surface area of the composition (SBET, expressed in m²/g) according to the following equation:

A_{[acid]}=10⁻⁴ DC×Q×S_{[acid]}/(SBET×m)

The acidity values, expressed as acid selectivity or as acid activity, obtained from the test that has just been described are given in Table 2 for each of the compositions that are the subject of the examples that follow.

### EXAMPLE 1

This example relates to the preparation of a composition based on zirconium, titanium and tungsten oxides in the respective proportions by mass of oxide of 47.5%, 47.5% and 5%.

1520 g of sodium hydroxide (concentration: 10 wt %) were stirred in a reactor and heated to 60° C. Separately, a mixture of the following solutions was prepared with stirring: 110 g of deionized water, 84 g of 20% sulfuric acid as a source of sulfate, 220 g of a zirconium oxychloride solution (concentration: 21.6% by weight of ZrO₂) and 264 g of a titanium oxychloride solution (concentration: 18.0% by weight of TiO₂).

The mixture of the above solutions was added to the sodium hydroxide at 60° C. over 2 hours via a peristaltic pump. At the end of the addition, hydrogen peroxide (115 g, concentration: 35%) was slowly added to the suspension over 30 minutes. The suspension was then filtered on a Buchner funnel and washed with 6 liters of deionized water at 60° C. The precipitate was then redispersed in water up to a volume of 1.5 liter with stirring. 7.3 g of solid sodium metatungstate (containing 69% by weight of WO₃) were added to the suspension and left with stirring for 1 hour. After 1 hour, nitric acid (concentration: 30% by weight of HNO₃) was added to the suspension until a pH of 4.0 was obtained. The suspension was brought to 60° C. and held at this temperature for 1 hour. After 1 hour, the suspension was filtered on a Buchner funnel and the solid was washed with 6 liters of deionized water at 60° C. The solid was then redispersed in deionized water with suitable stirring to a volume of 1 liter. The suspension was then treated at 144° C. for 5 hours.

The product obtained in this way was finally calcined in air for 2 hours at 750° C. as temperature hold. This product was characterized by a specific surface area of 55 m²/g. It showed 2 phases in X-ray diffraction: the TiO₂ anatase phase and the ZrTiO₄ phase which was predominant. The XRD diagram did not reveal the presence of tungsten oxide WO₃.

After calcination in air for 2 hours at 950° C. as temperature hold, the specific surface area was equal to 26 m²/g.

The product contained less than 120 ppm of sulfates, 50 ppm of sodium and less than 10 ppm of chlorides.

### EXAMPLE 2

This example relates to the preparation of a composition based on zirconium, titanium, tungsten and silicon oxides in the respective proportions by mass of oxide of 54%, 34.7%, 7.5% and 3.8%.

2028 g of sodium hydroxide (concentration: 10 wt %) were stirred in a reactor and heated to 60° C. Separately, a mixture of the following solutions was prepared with stirring: 245 g of deionized water, 29 g of 77% sulfuric acid as source of sulfate, 409 g of a zirconium oxychloride solution (concentration: 19.8% by weight of ZrO₂), 19 g of a silica sol (MORRISOL from Morrisons Gas Related Products Limited, concentration: 30% by weight of SiO₂) and 289 g of a titanium oxychloride solution (concentration: 18.0% by weight of TiO₂).

The mixture of the above solutions was added to the sodium hydroxide at 60° C. over 2 hours via a peristaltic pump. At the end of the addition, hydrogen peroxide (121 g, concentration: 35%) was slowly added to the suspension over 30 minutes. The suspension was then filtered on a Buchner funnel and washed with 6 liters of deionized water at 60° C. The precipitate was then redispersed in water up to a volume of 1.5 liter with stirring. 16.0 g of solid sodium metatungstate (containing 16% by weight of NO₃) were added to the suspension and left with stirring for 1 hour. After 1 hour, nitric acid (concentration: 30% by weight of HNO₃) was added to the suspension until a pH of 4.0 was obtained. The suspension was brought to 60° C. and held at this temperature for 1 hour. After 1 hour, the suspension was filtered on a Buchner funnel and the solid was washed with 6 liters of deionized water at 60° C. The solid was then redispersed in deionized water with suitable stirring to a volume of 1 liter. The suspension was then treated at 144° C. for 5 hours.

The product obtained in this way was finally calcined in air for 2 hours at 900° C. as temperature hold. This product was characterized by a specific surface area of 73 m²/g. It showed 2 phases in X-ray diffraction: the TiO₂ anatase phase and the ZrTiO₄ phase which was predominant. The XRD diagram did not reveal the presence of tungsten oxide NO₃ nor of silicon oxide SiO₂.

After calcination in air for 4 hours at 950° C. as temperature hold, the specific surface area was equal to 45 m²/g.

The product contained less than 120 ppm of sulfates, 50 ppm of sodium and less than 10 ppm of chlorides.

### EXAMPLE 3

This example relates to the preparation of a composition based on zirconium, titanium, tungsten, silicon and yttrium oxides in the respective proportions by mass of oxide of 53.4%, 34.3%, 7.5%, 3.8% and 1%.

1987 g of sodium hydroxide (concentration: 10 wt %) were stirred in a reactor and heated to 60° C. Separately, a mixture of the following solutions was prepared with stirring: 249 g of deionized water, 28.5 g of 77% sulfuric acid as a source of sulfate, 398 g of a zirconium oxychloride solution (concentration: 19.8% by weight of ZrO₂), 25.0 g of a silica sol (MORRISOL from Morrisons Gas Related Products Limited, concentration: 30% by weight of SiO₂), 7.8 g of a yttrium nitrate solution (concentration: 19.2% by weight of Y₂O₃) and 283 g of a titanium oxychloride solution (concentration: 18.0% by weight of TiO₂).

The mixture of the above solutions was added to the sodium hydroxide at 60° C. over 2 hours via a peristaltic pump. At the end of the addition, hydrogen peroxide (125 g, concentration: 35%) was slowly added to the suspension over 30 minutes. The suspension was then filtered on a Buchner funnel and washed with 6 liters of deionized water at 60° C. The precipitate was then redispersed in water up to a volume of 1.5 liter with stirring. 16.0 g of solid sodium metatungstate (containing 11.25% by weight of NO₃) were added to the suspension and left with stirring for 1 hour. After 1 hour, nitric acid (concentration: 30% by weight of HNO₃) was added to the suspension until a pH of 4.0 was obtained. The suspension was brought to 60° C. and held at this temperature for 1 hour. After 1 hour, the suspension was filtered on a Buchner funnel and the solid was washed with 6 liters of deionized water at 60° C. The solid was then redispersed in deionized water with suitable stirring to a volume of 1 liter. The suspension was then treated at 144° C. for 5 hours.

The product obtained in this way was finally calcined in air for 2 hours at 750° C. as temperature hold. This product was characterized by a specific surface area of 129 m²/g and a pure ZrTiO₄ phase. The XRD diagram did not reveal the presence of tungsten oxide WO₃ or of silicon oxide SiO₂ or of yttrium oxide Y₂O₃. After calcination in air for 2 hours at 950° C. as temperature hold, the specific surface area was equal to 42 m²/g.

The product contained less than 120 ppm of sulfates, 50 ppm of sodium and less than 10 ppm of chlorides.

### COMPARATIVE EXAMPLE 4

A γ-alumina sold by Condéa was impregnated by a solution of lanthanum nitrate in order to obtain, after drying and calcining in air at 500° C., an alumina stabilized by 10 wt % lanthanum oxide. The specific surface area was equal to 120 m²/g.

The acidity values of the compositions that are the subject of Examples 1 to 4 are given in Table 2 below.

TABLE 2

| | Acid selectivity | Acid activity |
|---|---|---|
| Composition | (%) | (mmol/h/m²) |
| Example 1 | 90 | 0.062 |
| Example 2 | 97 | 0.153 |
| Example 3 | 97 | 0.091 |
| Comparative | 25 | 0.004 |
| example 4 | | |

### EXAMPLE 5

This example describes a catalyst test for oxidizing carbon monoxide CO and hydrocarbons HC using the compositions prepared in the previous examples.

Preparation of Catalyst Compositions

The compositions prepared in the previous examples were impregnated by a tetraamine platinum (II) hydroxide salt (Pt(NH₃)₄(OH)₂) so as to obtain a catalyst composition containing 1 wt % platinum relative to the mass of oxides.

The catalyst compositions obtained were dried at 120° C. overnight then calcined at 500° C. in air for 2 h. They were then subjected to ageing before the catalyst test.

Ageing

Firstly, a synthetic gas mixture containing 10 vol % and 10 vol % H₂O in N₂ was made to circulate continuously over 400 mg of the catalyst composition in a quartz reactor containing the catalyst compound. The temperature of the reactor was brought to 750° C. and held there for 16 hours. The temperature was then brought back to room temperature.

Secondly, a synthetic gas mixture containing 20 vpm SO₂, 10 vol % O₂ and 10 vol % H₂O in N₂ was made to circulate continuously in a quartz reactor containing the catalyst compound. The temperature of the reactor was brought to 300° C. and held there for 12 hours.

The content of the element sulfur S in the catalyst composition was measured at the end of the ageing in order to evaluate its resistance to sulfation. Under the ageing conditions, the maximum sulfur content that could have been captured by the catalyst composition was 1.28 wt %. The lower the sulfur content after ageing, the higher its resistance to sulfation.

The aged catalyst compositions were then evaluated by a catalyst initiation temperature test (of the light-off type) for the oxidation reactions of CO, propane C₃H₈ and propene C₃H₆.

Catalyst Test

In this test a synthetic mixture, representing diesel engine exhaust gas containing 2000 vpm CO, 667 vpm H₂, 250 vpm C₃H₆, 250 vpm C₃H₈, 150 vpm NO, 10 vol % CO₂, 13 vol % O₂ and 10 vol % H₂O in N₂, was made to pass over the catalyst composition. The gas mixture was circulated continuously, with a flow rate of 301/h, in a quartz reactor containing between 20 mg of the catalyst compound diluted in 180 mg of silicon carbide SiC.

SiC is inert with respect to the oxidation reactions and here plays the role of diluent making it possible to ensure the homogeneity of the catalyst bed.

During a light-off test, the conversion of CO, propane C₃H₈ and propene C₃H₆ was measured as a function of the temperature of the catalyst composition. The catalyst composition was therefore subjected to a 10° C./min temperature ramp between 100° C. and 450° C. while the synthetic mixture was circulating in the reactor. The gases exiting the reactor were analyzed by infrared spectroscopy at about 10 s intervals in order to measure the conversion of the CO and hydrocarbons into CO₂ and H₂O.

The results were expressed as T_{EA} and T₅₀%, at which temperatures respectively 10% and 50% conversion of CO, propane C₃H₈ and propene C₃H₆ were measured.

Two temperature ramps were linked together. The catalytic activity of the catalyst composition was stabilized during the first ramp. The temperatures T₁₀% and T₅₀% were measured during the second ramp.

The results obtained after ageing are given below.

TABLE 3
(Resistance to sulfation)

| Composition | S content (wt %) |
|---|---|
| Example 1 | 0.17 |
| Example 2 | 0.16 |
| Example 3 | 0.36 |
| Comparative | 0.97 |
| example 4 | |

The compositions according to the invention are clearly more resistant to sulfation as the content of sulfur captured during the sulfation test is low.

The catalytic performances of the products from the examples are given in Tables 4 to 6 below.

TABLE 4
(CO T_{50%} before and after sulfation)

| | | | Change in T_{50%} |
|---|---|---|---|
| | CO T_{50%} (° C.) | CO T_{50%} (° C.) | before/after |
| Composition | before sulfation | after sulfation | (° C.) |
| Example 1 | 240 | 245 | +5 |
| Example 2 | 230 | 245 | +15 |
| Example 3 | 250 | 255 | +5 |
| Comparative | 220 | 245 | +30 |
| example 4 | | | |

TABLE 5
(C₃H₆ T_{50%} after sulfation)

| Composition | C₃H₆ T_{50%} (° C.) |
|---|---|
| Example 1 | 250 |
| Example 2 | 250 |
| Example 3 | 260 |
| Comparative | 255 |
| example 4 | |

TABLE 6
(C₃H₈ T_{10%} after sulfation)

| | C₃H₈ T_{10%} (° C.) |
|---|---|
| Composition | after sulfation |
| Example 1 | 325 |
| Example 2 | 320 |
| Example 3 | 315 |
| Comparative | 370 |
| example 4 | |

The results of Table 4 show, for the conversion of CO, a change in the catalytic properties of the compositions according to the invention after sulfation that is clearly lower than that of the comparative composition.

It should be noted that even if the performance of the compositions of the invention after sulfation is similar to that of the comparative composition, it nevertheless remains very advantageous, from an industrial point of view, to use products whose performance remains stable before and after sulfation.

In fact, the products of the prior art, undergoing a substantial change in their performance, make it necessary, when designing the catalysts, to allow for a higher quantity of these catalyst compounds than that which is theoretically needed to compensate for this loss of performance. This is no longer the case for the compositions of the invention.

In addition, it is observed from Table 6 that the conversion of propane starts at a lower temperature for the catalysts based on the compositions of the invention than for the comparative catalyst. To obtain propane conversions below 350° C. is likely to substantially improve the overall conversion level of hydrocarbons in the treated medium.

### EXAMPLE 6

This example relates to the preparation of a composition based on zirconium, titanium, silicon, tungsten and cerium oxides in the respective proportions by mass of oxide of 51.5%, 33%, 3.5%, 7% and 5%.

A solution A was prepared by mixing, in a beaker with stirring, 152.5 g of zirconyl chloride (20 wt % ZrO₂), 97 g of titanyl chloride (20 wt % TiO₂) and 25 g of sulfuric acid (97 wt %) with 125.5 g of distilled water.

Introduced into a stirred reactor were 675 g of a sodium hydroxide solution (10 wt % NaOH), then the solution A was gradually added with stirring. The pH of the medium reached a value of at least 12.5 by then adding a solution of sodium hydroxide. The precipitate obtained was filtered and washed at 60° C. with 3 l of distilled water. The solid was put back into suspension in 1 l of distilled water.

Introduced into this suspension, with stirring, were 12 g of sodium silicate (232 g/l SiO₂), 6 g of sodium metatungstate dihydrate and 13 g of distilled water. The pH was adjusted to 4 by addition of a solution of nitric acid (68 vol %). The medium was brought to 60° C. for 30 min, then the precipitate was again filtered and washed at 60° C. with 3 l of distilled water.

The solid was put back into suspension in 900 ml of distilled water and 11 g of cerium(III) nitrate (496 g/l CeO₂) were added. The medium was finally spray-dried on a Büchi spray drier at 110° C. (outlet temperature of the gases).

The dried solid was calcined in air at 750° C. and held there for 2 hours. This product was characterized by a specific surface area of 100 m²/g and a pure ZrTiO₄ phase.

The product contained less than 120 ppm of sulfates, 50 ppm of sodium and less than 10 ppm of chlorides.

### EXAMPLE 7

This example relates to the preparation of a composition based on zirconium, titanium, silicon, tungsten and cerium oxides in the respective proportions by mass of oxide of 48%, 31%, 3.5%, 7.5% and 10%.

A solution A was prepared by mixing, in a beaker with stirring, 134.5 g of zirconyl chloride (20 wt % ZrO₂), 86.5 g of titanyl chloride (20 wt % TiO₂) and 22 g of sulfuric acid (97 wt %) and 20 g of cerium(III) nitrate (496 g/l CeO₂) with 90 g of distilled water.

Introduced into a stirred reactor were 661 g of a sodium hydroxide solution (10 wt % NaOH), then the solution A was gradually added with stirring. The pH of the medium reached a value of at least 12.5 by then adding a solution of sodium hydroxide. 8 g of hydrogen peroxide (30 vol %) were introduced into the medium. After stirring for 30 min, the precipitate obtained was filtered and washed at 60° C. with 3 l of distilled water. The solid was put back into suspension in 1 l of distilled water.

Introduced into this suspension, with stirring, were 10 g of sodium silicate (232 g/l SiO₂), 5.9 g of sodium metatungstate dihydrate and 13 g of distilled water. The pH was adjusted to 4 by addition of a solution of nitric acid (68 vol %). The medium was brought to 60° C. for 30 min, then the precipitate was again filtered and washed at 60° C. with 3 l of distilled water.

The solid was dried overnight in an oven at 120° C., then the product obtained was calcined in air at 750° C. and held there for 2 hours. This product was characterized by a specific surface area of 99 m²/g and a pure ZrTiO₄ phase.

The product contained less than 120 ppm of sulfates, 50 ppm of sodium and less than 10 ppm of chlorides.

### EXAMPLE 8

This example relates to the preparation of a composition based on zirconium, titanium, silicon, tungsten and manganese oxides in the respective proportions by mass of oxide of 51.5%, 33%, 3.5%, 7% and 5%.

The procedure from Example 6 was followed except that 7.5 g of manganese(II) nitrate were introduced before the spray drying. The dried solid was calcined in air at 750° C. and held there for 2 hours. This product was characterized by a specific surface area of 75 m²/g and a pure ZrTiO₄ phase.

The product contained less than 120 ppm of sulfates, 50 ppm of sodium and less than 10 ppm of chlorides.

Given in Table 7 below are the acidity values of the compositions which are the subject of Examples 6 to 8.

TABLE 7

| | Acid selectivity | Acid activity |
|---|---|---|
| Composition | (%) | (mmol/h/m²) |
| Example 6 | 96 | 0.066 |
| Example 7 | 97 | 0.105 |
| Example 8 | 93 | 0.088 |

### COMPARATIVE EXAMPLE 9

A ZSM5 zeolite having a SiO₂/Al₂O₃ molar ratio of 30 was exchanged with a solution of iron acetylacetonate to obtain a Fe-ZSM5 zeolite containing 3 wt % of iron. The product was dried overnight in an oven at 120° C. and calcined in air at 500° C. The specific surface area was greater than 300 m²/g.

### EXAMPLE 10

This example describes a catalyst test for reducing nitrogen oxides NOx with aqueous ammonia NH₃ (NH₃—SCR) using the compositions prepared in the previous examples.

Ageing

A synthetic gas mixture containing 10 vol % O₂ and 10 vol % H₂O in N₂ was made to circulate continuously over 400 mg of the catalyst composition in a quartz reactor containing the catalyst compound. The temperature of the reactor was brought either to 750° C. and held there for 16 hours, or to 900° C. and held there for 2 hours. The temperature was then brought back to room temperature.

The fresh or aged catalyst compositions were then evaluated by a catalyst test of the conversion of NOx by NH₃ selective catalytic reduction (SCR).

Catalyst Test

In this test, a synthetic mixture representing the SCR application for diesel vehicles containing 500 vpm of NH₃, 500 vpm of NOx (NO₂/NO ═0 or 1), 7 vol % of O₂ and 2 vol % of H₂O in He was made to pass over the catalyst composition. The gas mixture was circulated continuously, with a flow rate of 60 ml/min in a quartz reactor containing 20 mg of catalyst compound diluted in 180 mg of silicon carbide SiC.

SiC is inert with respect to the oxidation reactions and here plays the role of diluent making it possible to ensure the homogeneity of the catalyst bed.

During a light-off test, the conversion of the NOx and the formation of N₂O was monitored as a function of the temperature of the catalyst composition. The catalyst composition was therefore subjected to a 5° C./min temperature ramp between 150° C. and 500° C. while the synthetic mixture was circulating the reactor. The gases exiting the reactor were analyzed by mass spectroscopy in order to monitor the concentrations of the various constituents of the gas mixture.

The results are expressed as the degree of conversion of the NOx at 200° C., 300° C. and 400° C. and maximum concentration of N₂O formed during the test.

The results obtained after ageing are given below.

TABLE 8
(reduction of NOx by NH₃)
aged 750° C./16 h

| | | NOx | NOx | NOx | Max N₂O |
|---|---|---|---|---|---|
| | | conversion | conversion | conversion | concen- |
| | | (%) at | (%) at | (%) at | tration |
| Composition | NO₂/NO | 200° C. | 300° C. | 400° C. | (vpm) |
| Ex 6 | 0 | 27 | 77 | 82 | <5 |
| ZrTiSiWCe | 1 | 75 | 95 | 95 | 5 |
| Ex 9 | 0 | 5 | 25 | 75 | 12 |
| Comparative | 1 | 62 | 70 | 90 | 13 |

TABLE 9
(reduction of NOx by NH₃)
NO₂/NO = 0, aged 900° C./2 h

| | NOx | NOx | NOx | |
|---|---|---|---|---|
| | conversion | conversion | conversion | Max N₂O |
| | (%) at | (%) at | (%) at | concentration |
| Composition | 200° C. | 300° C. | 400° C. | (vpm) |
| Ex 6 | 8 | 42 | 58 | <5 |
| ZrTiSiWCe | | | | |
| Ex 9 | 5 | 10 | 20 | 10 |
| Comparative | | | | |

Tables 8 and 9 show that the compositions according to the invention make it possible to obtain high conversions of the NOx in the temperature range of the diesel application while forming very little N₂O, and this even after severe ageing or variable NO₂/NO ratios.

1.-19. (canceled)

20. A composition comprising zirconium oxide, titanium oxide and tungsten oxide in the following proportions by mass of these various components:
titanium oxide: 20%-50%;
tungsten oxide: 1%-20%;
the remainder being zirconium oxide; and
having an acidity measured by the methylbutynol test of at least 90%.

21. A composition comprising zirconium oxide, titanium oxide, tungsten oxide and at least one oxide of at least one element M selected from among silicon, aluminum, iron, molybdenum, manganese, zinc, tin and the rare earths in the following proportions by mass of these various components:
titanium oxide: 20%-50%;
tungsten oxide: 1%-20%;
oxide of the element M: 1%-20%;
the remainder being zirconium oxide; and
having an acidity measured by the methylbutynol test of at least 90%.

22. The composition as defined by claim 20, having an acidity of at least 95%.

23. The composition as defined by claim 20, having, after calcination at 750° C. for 2 hours, a specific surface area of at least 50 m²/g.

24. The composition as defined by claim 21, wherein the element M comprises silicon and/or aluminum and having, after calcination at 750° C. for 2 hours, a specific surface area of at least 100 m²/g.

25. The composition as defined by claim 21, wherein the element M comprises silicon and/or aluminum and having, after calcination at 950° C. for 2 hours, a specific surface area of at least 40 m²/g.

26. The composition as defined by claim 20, comprising at least 40% of zirconium oxide.

27. The composition as defined by claim 20, having an acid activity of at least 0.05 mmol/h/m².

28. The composition as defined by claim 27, having an acid activity of at least 0.09.

29. A process for preparing a composition as defined by claim 21, comprising the following steps:
(a) bringing together in a liquid medium a zirconium compound, a titanium compound, optionally a compound of the element M and a basic compound whereby a precipitate is obtained;
(b) forming a suspension comprising the precipitate from step (a) or starting from the suspension from step (a), and either adding a tungsten compound thereto and adjusting the pH of the medium to a value ranging from 1 to 7, or adjusting the pH of the suspension thus formed to a value ranging from 1 to 7 and adding a tungsten compound thereto;
(c) maturing the suspension from the previous step; and
(d) calcining, optionally after drying, the product from the step (c).

30. A process for preparing a composition as defined by claim 21, comprising the following steps:
(a′) bringing together in a liquid medium a zirconium compound, a titanium compound and a basic compound whereby a precipitate is obtained;
(b′) forming a suspension comprising the precipitate from step (a′) or starting from the suspension from step (a′), and adding a tungsten compound and a compound of the element M thereto, and adjusting the pH of the medium to a value ranging from 1 to 7;
(c′) optionally maturing the suspension from the previous step; and
(d′) calcining, optionally after drying, the product from the step (c′).

31. A process for preparing a composition as defined by claim 21, which comprises at least two elements M, comprising the following steps:
(a″) bringing together in a liquid medium a zirconium compound, a titanium compound and a basic compound whereby a precipitate is obtained;
(b″) forming a suspension comprising the precipitate from step (a″) or starting from the suspension from step (a″), and adding a tungsten compound and a compound of at least one of the elements M thereto, and adjusting the pH of the medium to a value ranging from 1 to 7;
(c″) optionally maturing the suspension from the previous step;
(d″) separating the precipitate from the medium from step (c″), resuspending same in water and adding, to the suspension obtained, a compound of at least one other element M; and
(e″) calcining, optionally after drying, the product from the step (d″).

32. A process for preparing a composition as defined by claim 21, which comprises at least two elements M, comprising the following steps:
(a₁) bringing together in a liquid medium a zirconium compound, a titanium compound, a compound of at least one of the elements M and a basic compound whereby a precipitate is obtained;
(b₁) forming a suspension comprising the precipitate from step (a₁) or starting from the suspension from step (a₁), and adding a tungsten compound and a compound of at least one other of the elements M thereto, and adjusting the pH of the medium to a value ranging from 1 to 7;
(c₁) optionally maturing the suspension from the previous step; and
(d₁) calcining, optionally after drying, the product from the step (c₁).

33. The process as defined by claim 29, wherein the zirconium compound and the titanium compound are oxychlorides.

34. The process as defined by claim 29, wherein the first step is conducted in the presence of hydrogen peroxide or hydrogen peroxide is added at the end of this first step.

35. The process as defined by claim 29, wherein, at the end of the first step and before the second step, the precipitate is separated from the liquid medium and is resuspended in water.

36. A catalyst system comprising a composition as defined by claim 20.

37. A method for catalytically treating exhaust gases, employing a catalyst system as defined by claim 36 for the oxidation of the CO and hydrocarbons contained therein.

38. A method for catalytically treating exhaust gases from a diesel engine, employing a catalyst system as defined by claim 36 for the reduction of the nitrogen oxides (NOx) in the reduction reaction of these NOx by aqueous ammonia or urea.
